(19) United States
(12) Patent Application Publication
(10) Pub. No.: US 2014/0110012 A1
(43) Pub. Date: Apr. 24, 2014

(54) PARTIALLY MOLDED CORRUGATE TUBE

(71) Applicant: Yazaki Corporation, Tokyo (JP)

(72) Inventors: Takeyuki Omura, Susono-shi (JP); Hiroshi Ichikawa, Susono-shi (JP); Masahisa Sugimoto, Susono-shi (JP); Hiroshi Ishiuchi, Susono-shi (JP); Makoto Katsumata, Susono-shi (JP)

(73) Assignee: YAZAKI CORPORATION, Tokyo (JP)

(21) Appl. No.: 14/144,945

(22) Filed: Dec. 31, 2013

Related U.S. Application Data
(63) Continuation-in-part of application No. PCT/JP2012/004294, filed on Jul. 3, 2012.

(30) Foreign Application Priority Data
Jul. 5, 2011 (JP) 2011-148852

(51) Int. Cl. F16L 11/11

(52) U.S. Cl. CPC F16L 11/111
USPC 138/121

(57) ABSTRACT

A partially molded corrugate tube integrally includes: a straight tube portion, a small-diameter bellows tube portion, and a large-diameter bellows tube portion of which diameter is larger than the small-diameter bellows tube portion and integrally continued to the small-diameter bellows tube portion, and configured to be bent firstly. The small-diameter bellows tube portion is integrally continued to an end of the large-diameter bellows tube portion, and the straight tube portion is integrally continued to the other end of the large-diameter bellows tube portion. The large-diameter bellows tube portion is formed shorter than the small-diameter bellows tube portion in a longitudinal direction of the tube. A thickness T of a hill portion of the large-diameter bellows tube portion is gradually reduced as the hill portion extends toward a tip.

### TECHNICAL FIELD

This invention relates to a partially molded corrugate tube composed of a straight tube portion and a bellows tube portion for, for example, inserting and protecting a line-shaped object such as a wiring harness used in a vehicle.

### BACKGROUND ART

FIG. 3 shows an embodiment of a conventional corrugate tube (see PTL 1).

This corrugate tube 31 is used for connecting to a fuel tank of a vehicle. This corrugate tube 31 is made of synthetic resin material, and integrally composed of a long bellows tube portion 32 and a short straight tube portion 33 at an end of the long bellows tube portion 32 in a longitudinal (back and forth) direction of the long bellows tube portion 32. Each tube portion 32, 33 is formed in a circular sectional shape. A diameter of the straight tube portion 33 is smaller than a diameter of the long bellows tube portion 32. A thickness of the straight tube portion 33 is thicker than a thickness of the long bellows tube portion 32. One straight tube portion 33 is connected to a not-shown fuel tank, the other straight tube portion 33 is connected to a not-shown fill opening, and the middle long bellows tube portion 32 is bent to absorb a position gap between the fuel tank and the fill opening.

In the PTL 1, as a production method of the above corrugate tube, it is described that a partially molded corrugate tube 31 in FIG. 3 is attained by fixing a plurality of dividable molding dies to a pair of facing endless belts, by moving forward the molding die by rotations of the endless belts while pushing circularly thermoplastic resin material into the molding dies from an extruder to form continuously a partially molded corrugate tube in a long shape, and by cutting the long partially molded corrugate tube after cooling. The molding dies are composed of a bellows tube portion forming die having bellows-shaped circular concaves, and a straight tube portion forming die having a flat molding face. Each molding die has a vacuum hole.

Further, in PTL 2 (not shown), it is described that a synthetic-resin-made corrugate tube for inserting and protecting a plurality of electric wires (wiring harness) is composed of bellows tube portions having a circular sectional shape disposed front and rear in a longitudinal direction, and a wide and flat middle bellows tube portion integrally continued to the front and rear bellows tube portions. A thickness of the flat bellows tube portion is equal to an outer diameter of the front and rear bellows tube portions. This corrugate tube is routed in a floor or a trunk room of a vehicle while inserting a plurality of electric wires, and for example, the flat bellows tube portion is bent in a thickness direction with opening and closing of the trunk room.

### CITATION LIST

### Patent Literature

[PTL 1]
JP, A, 2010-260241
[PTL 2]
JP, A, H10-257634

### SUMMARY OF INVENTION

### Technical Problem

For example, the corrugate tube having the longer bellows tube portion 32 than the straight tube portion 33 such as the corrugate tube 31 of FIG. 3, when the corrugate tube into which the electric wires are inserted is routed along a curved wall of a vehicle body, because the whole bellows tube portion 32 is bent, there is a problem that it is difficult to bent solely a position required to be bent.

Therefore, as a corrugate tube 21 shown in FIG. 4, when a straight tube portion 22 is integrally provided with short (equal to or shorter than the straight tube portion 22) bellows tube portions 23 at both font and rear sides in a longitudinal direction, and at least one bellows tube portion 23 is disposed on a position required to be bent and bent in a large angle (in a small radius), a load applied to the bent portion of the one bellows tube portion becomes large, and there is a fear that a bending angle (bending radius) is regulated (the one bellow tube portion is not smoothly bent), and the bent portion may be bleached (weakened).

In view of the above, an object of the present invention is to provide a partially molded corrugate tube able to be bent smoothly in a large angle (small radius) at a position required to be bent without being bleached (weakened).

### Solution to Problem

For attaining the object, according to the invention claimed in claim 1, there is provided a partially molded corrugate tube integrally comprising: a straight tube portion, a small-diameter bellows tube portion, and a large-diameter bellows tube portion of which diameter is larger than the small-diameter bellows tube portion and integrally continued to the small-diameter bellows tube portion, and configured to be bent firstly.

According to the above configuration, for example, the large-diameter bellows tube portion is arranged at a position required to be bent, and bent in a large angle (small radius) in a radial direction, and the small-diameter bellows portion continued to the large-diameter bellows portion is smoothly bent in a small angle (large radius). Thereby, the small-diameter bellows tube portion is prevented from being bleached (weakened). Because the large-diameter bellows tube portion is more flexible than the small-diameter bellows tube portion, there is no fear that the large-diameter bellows tube portion may be bleached (weakened). Incidentally, in general, a diameter of the small-diameter bellow tube portion is larger than a diameter of the straight tube portion because a hill portion is projected. For example, the small-diameter bellows tube portion is continued to an end of the large-diameter bellows tube portion, and the straight tube portion or the other small-diameter bellows tube portion is continued to the other end of the large-diameter bellows tube portion (the straight tube portion is continued to the other small-diameter bellows tube portion).

According to the invention claimed in claim 2, there is provided the partially molded corrugate tube as claimed in claim 1,

wherein the small-diameter bellows tube portion is integrally continued to an end of the large-diameter bellows tube portion, and the straight tube portion is integrally continued to the other end of the large-diameter bellows tube portion.

According to the above configuration, the small-diameter bellows tube portion is smoothly bent in a small angle (large radius) about the large-diameter bellows tube portion, and the straight tube portion is extended straight in a tangential direction of the bent large-diameter bellows tube portion. Because the large-diameter bellows tube portion is interposed between the small-diameter bellows tube portion and the straight tube portion, an excessive bending load at a boundary between the small-diameter tube portion and the straight tube portion of the existing corrugate tube will be disappear.

According to the invention claimed in claim 3, there is provided the partially molded corrugate tube as claimed in claim 1 or 2,

wherein the large-diameter bellows tube portion is formed shorter than the small-diameter bellows tube portion in a longitudinal direction of the tube.

According to the above configuration, for example, the short-length large-diameter bellows tube portion is arranged at a position required to be bent, and correctly bent at the position required to be bent without a position gap in the longitudinal direction.

According to the invention claimed in claim 4, there is provided the partially molded corrugate tube as claimed in any one of claims 1 to 3,

wherein a thickness of a hill portion of the large-diameter bellows tube portion is gradually reduced as the hill portion extends toward a tip.

According to the above configuration, when the large-diameter bellows tube portion is bent in a large angle (small radius), tips of the hill portions of the large-diameter bellows tube portion at an inside bent portion are hard to abut on each other, and at the same time, valley portions of the large-diameter bellows tube portion at an outside bent portion are easy to open. Thereby, the large-diameter bellows tube portion is smoothly bent in a large angle (small radius) without being deformed.

### Advantageous Effects of Invention

According to the invention claimed in claim 1, with the large-diameter bellows tube portion, the corrugate tube can be smoothly bent in a large angle (small radius) at a position required to be bent without being bleached (weakened). Therefore, the corrugate tube and the wiring harness inserted into the tube are smoothly bent in a large angle (small radius) along a vehicle body or the like, and routed effectively. Further, the corrugate tube is prevented from being damaged or the like caused by the bleached bellows tube portion.

According to the invention claimed in claim 2, an excessive bending load generated at a boundary between the straight tube portion and the bellows tube portion in the existing corrugate tube is absorbed by the large-diameter bellows tube portion, thereby a bent portion is prevented from being bleached (weakened).

According to the invention claimed in claim 3, a bending position of the corrugate tube is correctly set by the short-length large-diameter bellows tube portion. When the short-length large-diameter bellows tube portion is arranged at a position required to be bent in a vehicle body or the like without a position gap, for example, a position gap of the corrugate tube in a back and forth direction is prevented, and a slack or a stress of the wiring harness guided out from the corrugate tube is surely prevented.

According to the invention claimed in claim 4, the tips of the hill portions do not abut on each other at an inside bent portion of the large-diameter bellows tube portion, and the hill portions are largely separated from each other in the longitudinal direction of the tube at an outside bent portion.

### BRIEF DESCRIPTION OF DRAWINGS

FIG. 1 is a front view showing an embodiment of a partially molded corrugate tube according to the present invention.

FIG. 2 is a front view showing a bent state of the partially molded corrugate tube.

FIG. 3 is a front view showing an embodiment of a conventional corrugate tube.

FIG. 4 is a front view showing another embodiment of the conventional corrugate tube.

### DESCRIPTION OF EMBODIMENTS

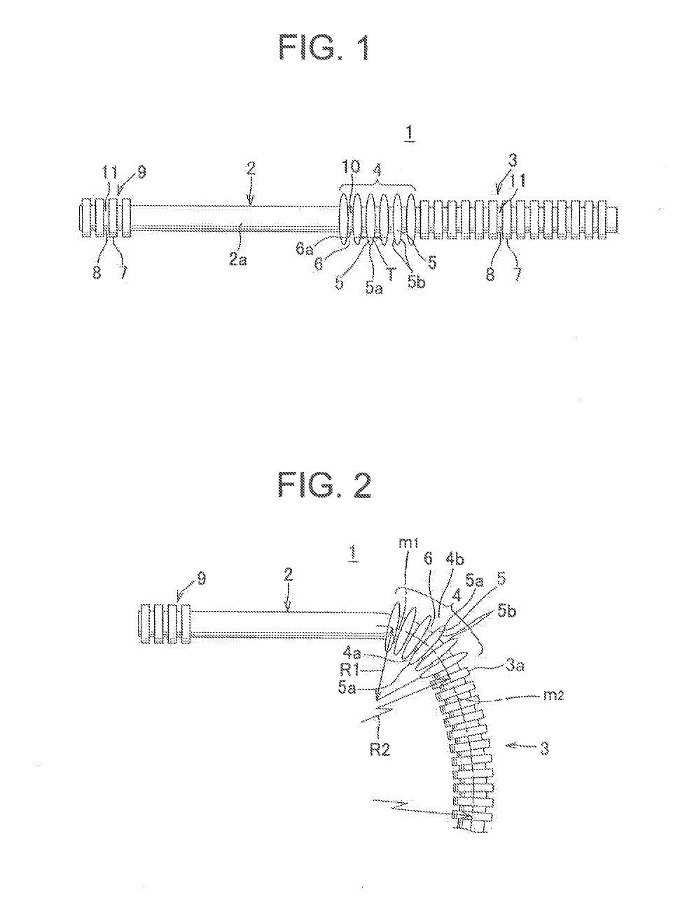

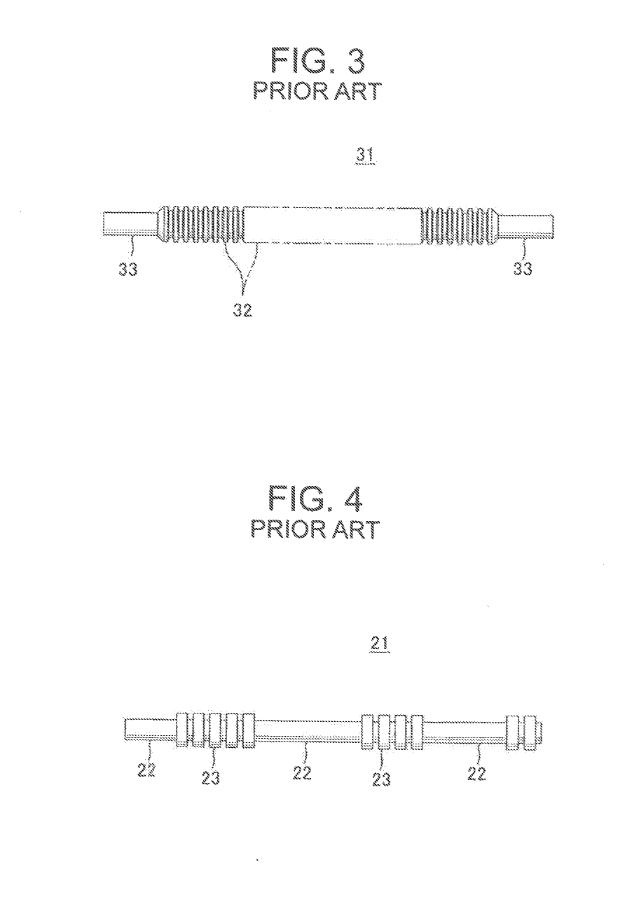

FIGS. 1 and 2 show an embodiment of a partially molded corrugate tube according to the present invention.

As shown in FIG. 1, this partially molded corrugate tube 1 is made of synthetic resin, and includes: a hard (rigid) small-diameter straight tube portion 2; a flexible middle-diameter bellows tube portion 3; and a flexible short-length large-diameter bellows tube portion 4 integrally continued to ends of the straight tube portion 2 and the middle-diameter bellows tube portion 3. The straight tube portion 2 is also referred to as a straight portion, and the bellows tube portions 3, 4 are also referred to as a corrugate portion.

As shown in FIG. 2, in the partially molded corrugate tube 1, the large-diameter bellows tube portion 4 is bent in a large angle (small radius R1), and the long-length middle-diameter bellows tube portion 3 continued to the large-diameter bellows tube portion 4 is smoothly bent in a small angle (large radius R2) along a wall surface of a vehicle body or the like to be assembled. The straight tube portion 2 continued to the large-diameter bellows tube portion 4 is not bent and extended straight.

Because the short-length large-diameter bellows tube portion 4 is bent in a large angle, an excessive bending load is not applied to the middle-diameter bellows tube portion 3 continued to an end of the large-diameter bellows tube portion 4, and an end 3a of the middle-diameter bellows tube portion 3 is perfectly protected from being bleached (weakened) or the like. Because the other end of the large-diameter bellows tube portion 4 is directly continued to the long straight tube portion 2, by bending the large-diameter bellows tube portion 4 in a large angle (small radius R1), the straight tube portion 2 is arranged straight in a desired direction.

The partially molded corrugate tube 1 in this embodiment is substantially equal to an embodiment in which the large-diameter bellows tube portion 4 is integrally arranged between a small-diameter straight tube portion 22 and a middle-diameter bellows tube portion 23 of a corrugate tube 21 in FIG. 4, and an end of the large-diameter bellows tube portion 4 is continued to the middle-diameter bellows tube portion 23, the other end of the large-diameter bellows tube portion 4 is continued to the straight tube portion 22.

The middle-diameter bellows tube portion 23 and the small-diameter straight tube portion 22 in FIG. 4 are shorter than the middle-diameter bellows tube portion 3 and the small-diameter straight tube portion 2 in FIG. 1. When the large-diameter bellows tube portion 4 is arranged in substantially the same length as the middle-diameter bellows tube portion 23 in FIG. 4, the same effect is achieved as the partially molded corrugate tube 1 of FIG. 2.

As one example, the partially molded corrugate tube 1 of FIG. 1 includes: the large-diameter bellows tube portion 4 having six hill portions (convex projections) 5; the middle-diameter bellows tube portion 3 having fourteen hill portions (convex projections) 7; and the small-diameter straight tube portion 2 having a flat outer peripheral wall 2a and substantially the same length as the middle-diameter bellows tube portion 3. The large-diameter bellows tube portion 4 is integrally continued to an end of the straight tube portion 2, and the second middle-diameter bellows tube portion 9 is integrally continued to the other end of the straight tube portion 2.

The second middle-diameter bellows tube portion 9 may extend in substantially the same length as the first middle-diameter bellows tube portion 3. Another not-shown straight tube portion may be continued to the second middle-diameter bellows tube portion 9. (In that case, preferably, a not-shown second large-diameter bellows tube portion (4) is integrally provided between the second middle-diameter bellows tube portion 9 and the another straight tube portion for routing the another straight portion in a large angle with respect to the second middle-diameter bellows tube portion 9.)

The middle-diameter bellows tube portions 3, 9 are formed in a rectangular wave sectional shape, and include a hill portion (convex projection) 7 projected in a substantially U sectional shape, and a valley portion (concave groove) 8 concaved in a substantially U sectional shape. The hill portions 7 and the valley portions 8 are formed on whole circumference of the circular sectional shaped middle-diameter bellows tube portion 3, 9, and arranged alternately in a regular pitch in the longitudinal direction of the tube.

The large-diameter bellows tube portion 4 is not formed in a rectangular wave sectional shape, but in a shape that a thickness of the hill portion (convex projection) 5 is gradually reduced as the hill portion 5 extends toward a tip 5a. Thereby, the large-diameter bellows tube portion 4 is more flexible than the rectangular wave sectional shaped middle-diameter bellows tube portions 3, 9. A side wall 5b of the hill portion 5 in front and rear in the longitudinal direction of the tube is expanded in a curve shape toward the projection tip 5a, while the thickness T is gradually reduced. The tip 5a of the hill portion 5 is not sharpened, but curved in a small radius.

A width of the valley portion 6 between the hill portions 5 is gradually reduced toward a bottom wall (outer peripheral wall of the tube main body) 6a. A width of a space (also denoted by 6) between the hill portions 5 is gradually increased toward the tip 5a of the hill portion 5. Thereby, as shown in FIG. 2, the large-diameter bellows tube portion 4 can be bent in a large angle (small radius R1).

Namely, in a bending condition of FIG. 2, because the tips 5a of the hill portions 5 are not abutted on each other in an inside bent 4a of the large-diameter bellows tube portion 4, the large-diameter bellows tube portion 4 can be bent in a large angle. Further, because the tips 5a of the hill portions 5 are projected largely in a radial direction of the tube in an outside bent 4b, when the large-diameter bellows tube portion 4 is bent in a large angle, the front and rear side walls 5b of the hill portions 5 are largely opened in an inverted trapezoidal shape about the tips 5a in the inner bent 4a. Thereby, tensile force in the longitudinal direction of the tube in the hill portions 5 is relaxed, and the large-diameter bellows tube portion 4 can be smoothly bent in a large angle.

In FIG. 1, an outer diameter of a tube main body 10 other than the hill portions 5 of the large-diameter bellows tube portion 4 is the same as an outer diameter other than the hill portions 7 of the middle-diameter bellows tube portion 3. These outer diameters are the same as an outer diameter of the straight tube portion 2. Each of the middle and large-diameter bellows tube portions 3, 4, 9 works as a bent portion, and the straight tube portion 2 works as a fixed shape portion. Therefore, it is also possible that an inner diameter of the straight tube portion 2 is formed smaller than inner diameters of the tube main bodies 10, 11 of the middle and large-diameter bellows tube portions 3, 4, 9, to increase a thickness of the straight tube portion 2. The thicknesses of the middle and large-diameter bellows tube portions 3, 4, 9 are the same. Inner peripheral walls of the bellows tube portions 3, 4, 9 are formed in a wave sectional shape similar to the outer peripheral walls.

As shown in FIG. 2, the long-length middle-diameter bellows tube portion 3 is smoothly curved with a bent center line m2 in substantially an are shape in a large radius continued to an arc-shaped bent center line m1 in a small radius of the short-length large-diameter bellows tube portion 4. In this embodiment, a bending angle of the large-diameter bellows tube portion 4 with respect to the straight tube portion 2 is a little more than 90 degrees, and a bending angle of the large-diameter bellows tube portion 4 and the middle-diameter bellows tube portion 3 is substantially 90 degrees. The bending angle of the large-diameter bellows tube portion 4 may be 90 degrees or more.

In the above embodiment, the large-diameter bellows tube portion 4 is continued to an end of the straight tube portion 2. However, for example, a short or long middle-diameter bellows tube portion 3, 9 may be integrally continued to both front and rear ends of the large-diameter bellows tube portion 4.

In this case, the straight tube portion 2 is integrally continued to one and/or the other of the middle-diameter bellows tube portions 3, 9 continued to the front and rear ends of the large-diameter bellows tube portion 4. Because the large-diameter bellows tube portion 4 is more flexible than the middle-diameter bellows tube portions 3, 9, even when the middle-diameter bellows tube portions 3, 9 are continued to the both front and rear ends of the large-diameter bellows tube portion 4, the large-diameter bellows tube portion 4 is bent in a large angle (small radius), and the middle-diameter bellows tube portions 3, 9 are bent in a small angle (large radius) and smoothly continued to the large-diameter bellows tube portion 4.

Preferably, the large-diameter bellows tube portion 4 and the middle-diameter bellows tube portion 3 are arranged in series. For example, when the straight tube portion 2 is interposed between the large-diameter bellows tube portion 4 and the middle-diameter bellows tube portion 3, the large-diameter bellows tube portion 4 and the middle-diameter bellows tube portion 3 are separately bent, and it is difficult for the partially molded corrugate tube 1 to be bent in a desired (required) position, and the partially molded corrugate tube 1 is not smoothly bent.

As shown in FIG. 2, when the straight tube portion 2 is continued to the large-diameter bellows tube portion 4, because the straight tube portion 2 is not bent, the large-diameter bellows tube portion 4 is mainly bent (the middle-diameter bellows tube portion 3 is dependently bent), thereby a connection portion (boundary portion) between the straight tube portion 2 and the large-diameter bellows tube portion 4 is prevented from being bleached (weakened), and a pending position (a position of the large-diameter bellows tube portion 4 is the bending position) can be correctly set.

The straight tube portion 2 works as the fixed shape portion, and when the partially molded corrugate tube 1 is routed (assembled) in a vehicle body or the like, a guiding out direction of a plurality of electric wires (wiring harness) previously inserted into the partially molded corrugate tube 1 can be easily and correctly set.

Incidentally, in the above embodiment, an outer diameter of the hill portion 7 of the middle-diameter bellows tube portion 3, 9 is formed larger than an outer diameter of the straight tube portion 2. However, for example, the outer diameter of the hill portion 7 of the middle-diameter bellows tube portion 3, 9 may be the same as the outer diameter of the straight tube portion 2. (In this case, the middle-diameter bellows tube portion 3, 9 is referred to as a small-diameter bellows tube portion.) In this case also, of course, the outer diameter of the large-diameter bellows tube portion 4 is larger than the outer diameter of the small-diameter bellows tube portion (3, 9).

Further, as a line-shaped object, a water-supplying pipe of which outer diameter is larger than the outer diameter of the electric wire, an optical fiber of which outer diameter is smaller than the outer diameter of the electric wire, or the like other than the electric wire can be inserted into the partially molded corrugate tube 1. To provide a not-shown slit in a longitudinal direction on the partially molded corrugate tube 1 for inserting the line-shaped object easily into the partially molded corrugate tube 1 is well-known. Further, the partially molded corrugate tube 1 is also referred to as a harness protecting tube, a harness exterior member, or the like.

### INDUSTRIAL APPLICABILITY

A partially molded corrugate tube according to the present invention can be bent in a large angle (small radius) at a position required to be bent without being bleached (weakened), and for example, used for smoothly bending and routing a wiring harness along a vehicle body or the like.

### REFERENCE SIGNS LIST

1 partially molded corrugate tube
2 straight tube portion
3 middle-diameter bellows tube portion
4 large-diameter bellows tube portion
5 hill portion
5a tip
T thickness

1. A partially molded corrugate tube integrally comprising: a straight tube portion, a small-diameter bellows tube portion, and a large-diameter bellows tube portion of which diameter is larger than the small-diameter bellows tube portion and integrally continued to the small-diameter bellows tube portion, and configured to be bent firstly.

2. The partially molded corrugate tube as claimed in claim 1,
wherein the small-diameter bellows tube portion is integrally continued to an end of the large-diameter bellows tube portion, and the straight tube portion is integrally continued to the other end of the large-diameter bellows tube portion.

3. The partially molded corrugate tube as claimed in claim 1,
wherein the large-diameter bellows tube portion is formed shorter than the small-diameter bellows tube portion in a longitudinal direction of the tube.

4. The partially molded corrugate tube as claimed in claim 2,
wherein the large-diameter bellows tube portion is formed shorter than the small-diameter bellows tube portion in a longitudinal direction of the tube.

5. The partially molded corrugate tube as claimed in claim 1,
wherein a thickness of a hill portion of the large-diameter bellows tube portion is gradually reduced as the hill portion extends toward a tip.

6. The partially molded corrugate tube as claimed in claim 2,
wherein a thickness of a hill portion of the large-diameter bellows tube portion is gradually reduced as the hill portion extends toward a tip.

7. The partially molded corrugate tube as claimed in claim 3,
wherein a thickness of a hill portion of the large-diameter bellows tube portion is gradually reduced as the hill portion extends toward a tip.

8. The partially molded corrugate tube as claimed in claim 4,
wherein a thickness of a hill portion of the large-diameter bellows tube portion is gradually reduced as the hill portion extends toward a tip.
